(19) United States
(12) Patent Application Publication
(10) Pub. No.: US 2007/0235301 A1
(43) Pub. Date: Oct. 11, 2007

(54) Activation Mechanism For A Personal Locator Beacon

(75) Inventor: Brian Clayton, London (GB)

Correspondence Address: ADAMS EVANS P.A., Suite 2350 Charlotte Plaza, 201 South College Street, CHARLOTTE, NC, 28244, US

(73) Assignee: SIGNATURE INDUSTRIES LIMITED, Thamesmead, London (GB)

(21) Appl. No.: 10/560,100

(22) PCT Filed: Jun. 10, 2004
(86) PCT No.: PCT/GB04/02464

§ 371 Date: May 16, 2007

(30) Foreign Application Priority Data
Jun. 13, 2003 (GB) 0313649.6

(51) Int. Cl. H01R 33/955

(52) U.S. Cl. 200/51.13

(57) ABSTRACT

A key ring (160) is attached by a lanyard to part of an air craft. Upon the air crew ejecting a leash retains the pull pin (120) within the air craft to remove the pin from the housing (140). This activates a personal locator beacon. Removal of the pin (120) allows a plunger switch extending upwardly from the locator beacon to be released to activate the beacon.

The invention relates to an activation mechanism for a personal locator beacon.

Personal locator beacons are devices designed to alert the rescue authorities of an emergency situation. For instance, military flying personnel are equipped with such locator beacons to aid in their location following aircraft ejection.

Previously, personal locator beacons were activated manually by a user following an emergency situation. However it will be evident that in some situations, manual activation may be inconvenient or impossible. For instance, in the event of a necessary aircraft ejection aircrew may be rendered unconscious and unable to manually activate their location beacons.

It is an aim of embodiments of the present invention to provide a personal locator beacon activation mechanism which overcomes the abovementioned disadvantages.

According to a first aspect of the invention, there is provided an activation mechanism for a personal locator beacon, the activation mechanism comprising: a removable actuator pin; a pin housing fixedly attached to the personal locator beacon for removably associating the pin with the locator beacon; and a pin withdrawal mechanism for automatically disassociating the pin from the locator beacon in the event of an emergency, withdrawal of the pin causing activation of the personal locator beacon.

Preferably, the removable actuator pin and the pin housing are arranged to cooperate with one another by means of mutually engaging members. Preferably, the mutually engaging members form a detent mechanism. Preferably, the detent mechanism comprises a protrusion cooperating with an indentation. Preferably, the protrusion and indentation comprise cooperating parts of the housing and the pin respectively.

Preferably, the activation mechanism is arranged such that the housing may be oriented on the personal locator beacon in one of a plurality of positions according to a desired pin entry/exit angle. Preferably, the housing may be oriented with respect to the beacon such that the pin may be withdrawn from the housing in a sideways direction. Alternatively, the housing may be oriented with respect to the beacon such that the pin may be withdrawn at an angle approximately orthogonal to the sideways direction.

Variable orientation is preferably provided to account for the variety of possible positions on a flight suit on which the beacon may be worn, so as to ensure that wherever it is preferred to wear the beacon a smooth removal of the pin may be ensured.

Preferably, the pin is slidably engageable with the housing. Preferably, the housing comprises a pin insertion region and a pin reception region into which the pin may be slidably introduced and positively locked into position by means of the detent mechanism.

Preferably, the detent mechanism comprises a flexible finger forming part of the housing and including a protrusion for engaging with a corresponding indentation in the pin.

Preferably, insertion of the pin into the insertion region of the housing causes deflection of the finger and, further insertion of the pin allows the protrusion on the finger to seat within the indentation of the pin.

Preferably, the pin includes a deflection ramp which is inclined with respect to a sliding plane of insertion of the pin, whereby insertion of the pin into the insertion region of the housing causes the deflection ramp to connect with the housing finger and cause deflection of the finger.

Preferably, means are provided on the housing or the pin or a body portion of the beacon itself to prevent mis-insertion of the pin into the housing. Such means preferably comprises suitably arranging the geometry of the pin and housing so as to only enable insertion of the pin from a desired side of the housing. For instance, a shoulder may be provided internally of the housing to prevent the pin from being inserted into the insertion region from the wrong direction.

Preferably, the indentation formed in the pin comprises a V-shaped groove whose formation is arranged to correspond closely to the formation of the finger protrusion.

Preferably, once inserted into the housing, the cooperation of indentation and protrusion is arranged to resist removal of the pin from the housing.

Preferably, the geometric configuration of the indentation and protrusion is selected according to a desired resistance to withdrawal of the pin. Here, variation of one or more of the depth of protrusion/indentation, angular configuration of the protrusion/indentation, thickness of finger and material properties of the finger may be made to alter the desired resistance.

Choosing an appropriate resistance to withdrawal of the pin is important to allow for a variety of aircrew weights and sizes, more resistance being required for heavier aircrew.

Preferably, the pin is provided with engagement means for cooperation with the pin withdrawal mechanism. The engagement means may comprise a through bore formed in an extension of the pin which is arranged to extend beyond an outer periphery of the housing when the pin is received within the housing. Preferably, the pin withdrawal mechanism comprises a key ring or like mechanism which is arranged to extend through the bore formed in the pin and to be joined to an external surface.

Preferably, the pin is arranged to be connected by means of a leash to a fixed point and, movement of the personal locator beacon away from the fixed point, beyond an extent of the leash causes the pin to be pulled away from the housing.

Preferably, the personal locator beacon is arranged to form part of the equipment of aircrew and the pin is arranged to be attached by leash to part of an aircraft, such that, ejection of the pilot from the aircraft causes the pin to disengage from the housing.

It is preferable that the pin should not be disturbed from the housing accidentally and, for this reason, the detent mechanism retaining the pin within the housing is preferably arranged to resist inadvertent removal of the pin. The degree of ease of removal of the pin from the housing is preferably dependent upon the profile of both the protrusion and the corresponding indentation forming the detent means.

Preferably, removal of the pin from the housing causes activation of the personnel locator beacon.

For a better understanding of the invention, and to show how embodiments of the same may be carried into effect, reference will now be made, by way of example, to the accompanying diagrammatic drawings in which:

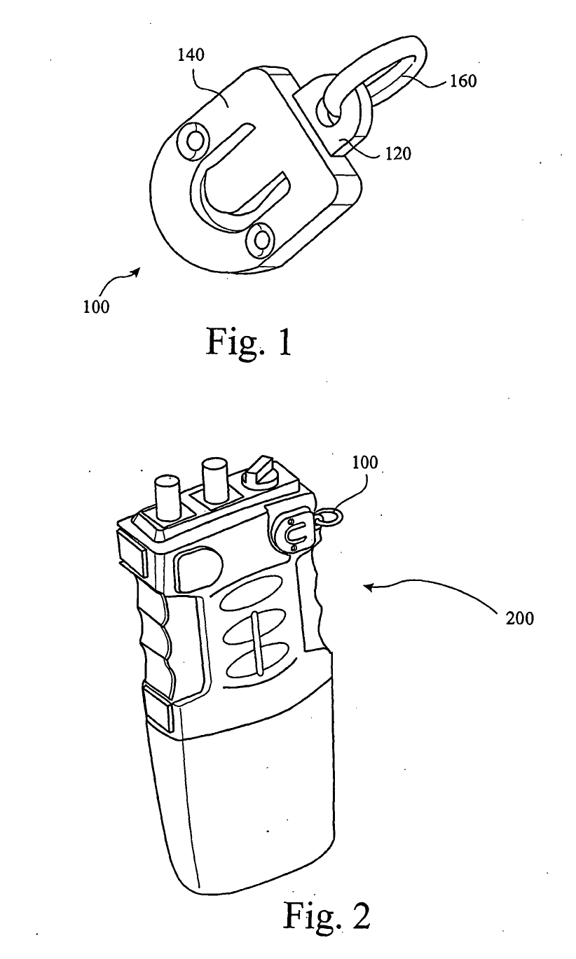

FIG. 1 is a schematic perspective view of an activation mechanism in accordance with embodiments of the present invention;

FIG. 2 is a schematic perspective view showing a personal locator beacon and associated activation mechanism;

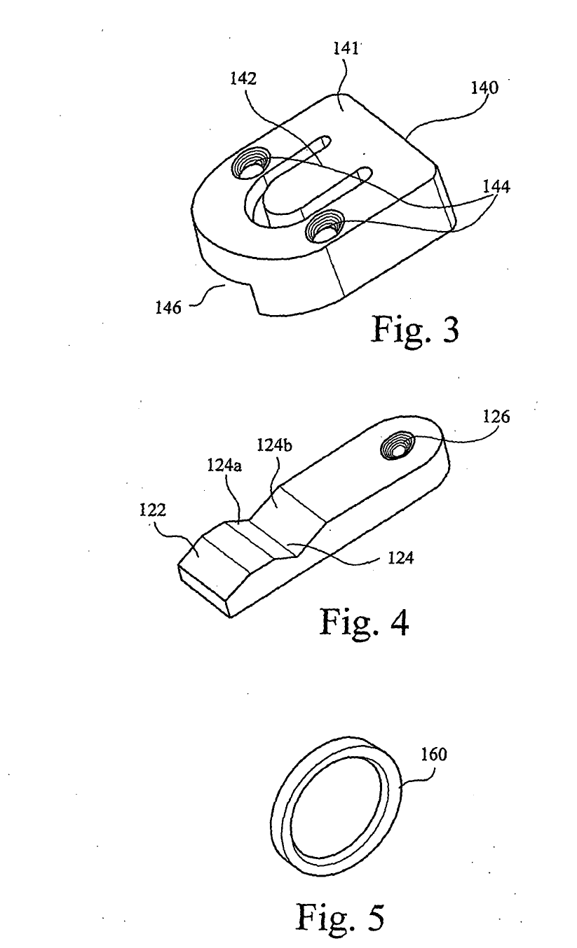

FIG. 3 is a top plan perspective view of a housing of the activation mechanism of FIG. 1;

FIG. 4 is a plan perspective view of a pin forming part of the activation mechanism of FIG. 1;

FIG. 5 shows a key ring for use in association with the pin and housing of FIGS. 3 and 4; and

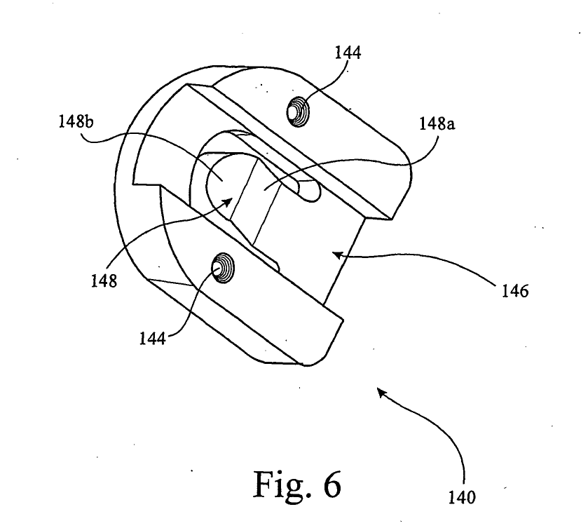

FIG. 6 is a perspective view of the housing of FIG. 3 as seen from underneath.

Referring initially to FIG. 1, there is shown an activation mechanism for a personal locator beacon. In brief, the activation mechanism comprises a pin 120, hereinafter referred to as pull-pin, a housing 140 and a key ring 160.

Referring to FIG. 2, the activation mechanism of FIG. 1 is shown associated with a personal locator beacon 200.

Referring now to FIG. 3, the housing 140 comprises a one-piece plastics moulded member including a relatively rigid main housing 141, within which a finger 142 extends centrally. The housing 140 further comprises mounting means 144 for fixedly associating the housing with the locator beacon 200, here, the mounting means are shown as comprising screw holes. Also, the housing 140 includes, as can best be seen from FIG. 6, pin insertion region 146 effectively forming a slot into which the pin 120 (to be described hereinafter) is a sliding fit. The finger 142 includes a protruding region 148 comprising a pair of downwardly extending ramps 148a, 148b.

The pull-pin 120 of FIG. 4 comprises an elongate member having a smooth bottom surface (not shown) and a shaped top surface including a first ramped region 122 and an indentation 124 formed by co-operating ramped surfaces 124a, 124b. The pull-pin 120 further comprises a through bore 126 which is arranged to cooperate with the key ring 160.

The key ring 160 of FIG. 5, whilst being shown as a continuous member, preferably is formed from a loop of material which may be deformed in conventional key ring manner in order to allow it to be threaded into the bore 126 of the pull-pin 120 to assume the configuration shown generally in FIG. 1.

Now that the individual parts of the activation mechanism for the personal locator beacon have been described, the cooperation of those elements will be described, and then an example will be given as to how the activation mechanism is arranged to function.

In use, it will be appreciated that the housing 140 of the activation mechanism is arranged to be fixedly attached to the surface of the personal locator beacon shown in FIG. 2. This fixed attachment may be accomplished by means of, for instance, screw fixing the housing 140 to the personal locator beacon by means of screws passing through the bores 144 and into a body portion of the beacon 200.

It will be appreciated from FIG. 6 that the internal formation of the cover 140 is generally arranged so as to have parallel interior walls for guiding the pull-pin 120 in a linear fashion into the housing 140. The insertion region 146 formed in the housing 140 effectively forms a slot into which the pull-pin 120 may be inserted. This slot is shown as being open at both ends but, it will be appreciated, may be open at one end only to prevent mis-insertion of the pin from the wrong end. Alternatively, to having a closed end of the housing, other means (not shown) may be provided on the housing or the pin or a body portion of the beacon itself to prevent such mis-insertion of the pin into the housing. Such means could comprise suitably arranging the geometry of the pin and housing so as to only enable insertion of the pin from a desired side of the housing. For instance, a shoulder may be provided internally of the housing to prevent the pin from being inserted into the insertion region from the wrong direction.

In order to associate the pull-pin 120 with the housing 140, the pull-pin is slidably inserted into the insertion region 146 of the housing 140. As the pin 120 slides further into the slot, the leading ramped edge 122 of the pin 120 will come into contact with the downwardly extending protrusion 148 formed on the finger 142. The ramp 122 acts so as to deflect the finger outwardly. Thereafter, a point is reached at which the ramp surface 122 has deflected the finger 142 to a maximum extent, after which, the resilient nature of the finger 142 causes the finger to snap back into essentially its original position and the ramped surfaces 148a, 148b of the protrusion 148 of the finger 142 engage with and sit within the indentation formed by the mutually inclined surfaces 124a, 124b of the pull-pin. The mutual cooperation of protrusion and indentation, form a detent mechanism which resists further insertion, or removal, of the pin 120 into/from the housing 140. The degree of resistance to removal of the pull-pin 120 from the housing 140 depends upon the steepness and depth of the corresponding ramps 124a, 124b, 148a, 148b. It will be appreciated that the shallower the angle of inclination of the various ramps with respect to the horizontal plane (i.e. with respect to the smooth under surface of the pin 120), the easier the pin 120 is to remove from the housing 140. In contrast, the steeper the degree of inclination, the more difficulty will be encountered in removing the pull-pin 120. Also effecting the ease of removal of the pin 120 is the relative resiliency (or hardness) of the finger 142.

As can be seen from FIGS. 1 and 2, when the pull-pin is inserted into the housing 140 and resiliently held within it, the key ring 160 is freely accessible from the side of the personal locator beacon 200.

In use, the key ring 160 may be attached by a lanyard (leash) to a part of the interior of an aircraft in which flying personnel operate. Should ejection of the aircrew be necessary, then the leash will cause force to be put upon the key ring 160 to try and retain the pull-pin 120 within the aircraft. Here, the resistance to removal of the pin 120 from the housing 140 is arranged so as to be high enough to avoid inadvertent removal of the pin 120, but low enough such that the leash attaching the key ring to the aircraft is not unduly strained during an aircrew ejection so that the pull-pin 120 disassociates from the housing 140 without causing the leash to break.

Disassociation of the pull-pin 120 from the housing 140 is arranged so as to activate the personal locator beacon to cause it to start transmitting location signals. This activation may be achieved, for instance, by the bottom sliding surface of the pin 120 allowing a plunger switch upwardly extending from the locator beacon to be released, alternatively, the pull-pin may itself comprise a suitable conductor mechanism which, when removed, causes the breaking or making of a circuit within the personal locator beacon to turn that beacon on. As will be appreciated, the actual switching on of the locator beacon by removal of the pin 120 may be achieved in a variety of ways and the manners of activation just described, are not to be construed as limiting.

The housing 140 can be fixed in a horizontal or vertical aspect providing optional positions for the mounting of the beacon on the pilots flying suit, or some other piece of equipment.

It will be appreciated that numerous variations and modifications to the activation mechanism may be contemplated without departing from the scope of the invention. For instance, while the finger 142 is described as including a protrusion and the pin 120 as including an indentation, this situation may be reversed, i.e. indentation on finger 142, protrusion on pin 120.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An activation mechanism for a personal locator beacon, the mechanism comprising: a removable actuator pin; a pin housing fixably attached to the personal locator beacon for removably associating the pin with the locator beacon and a pin withdrawal mechanism for automatically disassociating the pin from the locator beacon in the event of an emergency, withdrawal of the pin causing activation of the personal locator beacon.

2. A mechanism as claimed in claim 1 in which the removable pin and the pin housing are arranged to cooperate with one another by means of mutually engaging members, the mutually engaging members forming a detent mechanism, the detent mechanism comprising a protrusion cooperating with an indentation.

3. (canceled)

4. (canceled)

5. A mechanism as claimed in claim 2 in which the protrusion and the indentation comprise cooperating parts of the housing and the pin respectively.

6. A mechanism as claimed in claim 1 arranged such that the housing may be orientated on the personal locator beacon in one of a plurality of positions according to a desired pin entry/exit angle.

7. A mechanism as claimed in claim 6 in which the housing is orientated with respect to the beacon such that the pin may be withdrawn from the housing in a sideways direction.

8. A mechanism as claimed in claim 6 in which the housing is orientated with respect to the beacon such that the pin may be withdrawn at an angle approximately orthogonal to the sideways direction.

9. A mechanism as claimed in claim 6 in which the variable orientation is provided to account for the variety of possible positions on a flight suit on which the beacon may be worn.

10. A mechanism as claimed in claim 1 in which the pin is slidably engageable with the housing.

11. A mechanism as claimed in claim 2 in which the housing comprises a pin insertion region and a pin reception region into which the pin may be slidably introduced and positively locked into position by means of the detent mechanism.

12. A mechanism as claimed in claim 2 in which the detent mechanism comprises a flexible finger forming part of the housing and including a protrusion for engaging with the corresponding indentation in the pin.

13. A mechanism as claimed in claim 12 in which insertion of the pin into the insertion region of the housing causes deflection of the finger and further insertion of the pin allows the protrusion on the finger to seat within the indentation of the pin.

14. A mechanism as claimed in claim 13 in which the pin includes a deflection ramp which is inclined with respect to the sliding direction of insertion of the pin whereby insertion of the pin into the insertion region of the housing causes the deflection ramp to connect with the housing finger and cause deflection of the finger.

15. A mechanism as claimed in claim 1 in which means are provided on the housing or the pin or a body portion of the beacon itself to prevent mis-insertion of the pin into the housing.

16. A mechanism as claimed in claim 15 in which the means to prevent mis-insertion comprises suitably arranging the geometry of the pin and the housing so as to only enable insertion of the pin from a desired side of the housing.

17. A mechanism as claimed in claim 16 in which a shoulder is provided internally of the housing to prevent the pin from being inserted into insertion region from the wrong direction.

18. A mechanism as claimed in claim 12 in which the indentation of the pin comprises a V-shaped groove whose formation is arranged to correspond closely to the formation of the finger protrusion.

19. A mechanism as claimed in claim 2 in which the pin, once inserted into the housing, cooperation of the indentation and protrusion is arranged to resist removal of the pin from the housing.

20. A mechanism as claimed in claim 2 in which the geometric configuration of the indentation and protrusion is selected according to a desired resistance to withdrawal of the pin.

21. A mechanism as claimed in claim 1 in which the pin is provided with engagement means for cooperation with the pin withdrawal mechanism.

22. A mechanism as claimed in claim 21 in which the engagement means comprise a through bore formed in an extension of the pin which is arranged to extend beyond an outer periphery of the housing when the pin is received within the housing.

23. A mechanism as claimed in claim 21 or 22 in which the pin withdrawal mechanism comprises a key ring or like mechanism arranged to extend through the bore formed in the pin and to be joined to an external surface.

24. A mechanism as claimed in claim 1 in which the pin is arranged to be connected by a leash to a fixed point and, movement of the personal locator beacon away from the fixed point, beyond an extent of the leash causes the pin to be pulled from the housing.

25. (canceled)

26. A method of operating an activation mechanism of a personal locator beacon when the activation mechanism is as claimed in claim 1.

27. A method of operating an activation mechanism of a personal locator beacon when the activation mechanism is as claimed in claim 20 comprising varying resistance to the withdrawal of the pin from the mechanism.
